(19) United States
(12) Patent Application Publication
(10) Pub. No.: US 2017/0059305 A1
(43) Pub. Date: Mar. 2, 2017

(54) ACTIVE ILLUMINATION FOR ENHANCED DEPTH MAP GENERATION

(71) Applicant: Lytro, Inc., Mountain View, CA (US)

(72) Inventors: Thomas Nonn, Berkeley, CA (US); Zejing Wang, Mountain View, CA (US)

(21) Appl. No.: 14/834,924

(22) Filed: Aug. 25, 2015

(51) Int. Cl. G01B 11/22; G01B 11/25; G01B 11/14

(52) U.S. Cl. CPC G01B 11/22; G01B 11/14; G01B 11/2513

(57) ABSTRACT

A depth map may be generated in conjunction with generation of a digital image such as a light-field image. A light pattern source may be used to project a light pattern into a scene with one or more objects. A camera may be used to capture first light and second light reflected from the one or more objects. The first light may be a reflection of light originating from one or more other light sources independent of the light pattern source. The second light may be a reflection of the light pattern from the one or more objects. In a processor, at least the first light may be used to generate an image such as a light-field image. Further, in the processor, at least the second light may be used to generate a depth map indicative of distance between the one or more objects and the camera.

### CROSS-REFERENCE TO RELATED APPLICATIONS

The present application is related to U.S. application Ser. No. 13/774,925 for “Compensating for Sensor Saturation and Microlens Modulation During Light-Field Image Processing” (Atty. Docket No. LYT019), filed Feb. 22, 2013, issued on Feb. 3, 2015 as U.S. Pat. No. 8,948,545, the disclosure of which is incorporated herein by reference in its entirety.

The present application is related to U.S. Utility application Ser. No. 13/774,971 for “Compensating for Variation in Microlens Position During Light-Field Image Processing” (Atty. Docket No. LYT021), filed on Feb. 22, 2013, issued on Sep. 9, 2014 as U.S. Pat. No. 8,831,377, the disclosure of which is incorporated herein by reference in its entirety.

The present application is related to U.S. Utility application Ser. No. 13/774,986 for “Light-Field Processing and Analysis, Camera Control, and User Interfaces and Interaction on Light-Field Capture Devices” (Atty. Docket No. LYT066), filed on Feb. 22, 2013, issued on Mar. 31, 2015 as U.S. Pat. No. 8,995,785, the disclosure of which is incorporated herein by reference in its entirety.

The present application is related to U.S. Utility application Ser. No. 13/688,026 for “Extended Depth of Field and Variable Center of Perspective in Light-Field Processing” (Atty. Docket No. LYT003), filed on Nov. 28, 2012, issued on Aug. 19, 2014 as U.S. Pat. No. 8,811,769, the disclosure of which is incorporated herein by reference in its entirety.

The present application is related to U.S. Utility application Ser. No. 11/948,901 for “Interactive Refocusing of Electronic Images,” (Atty. Docket No. LYT3000), filed Nov. 30, 2007, issued on Oct. 15, 2013 as U.S. Pat. No. 8,559,705, the disclosure of which is incorporated herein by reference in its entirety.

The present application is related to U.S. Utility application Ser. No. 12/703,367 for “Light-field Camera Image, File and Configuration Data, and Method of Using, Storing and Communicating Same,” (Atty. Docket No. LYT3003), filed Feb. 10, 2010, now abandoned, the disclosure of which is incorporated herein by reference in its entirety.

The present application is related to U.S. Utility application Ser. No. 13/027,946 for “3D Light-field Cameras, Images and Files, and Methods of Using, Operating, Processing and Viewing Same” (Atty. Docket No. LYT3006), filed on Feb. 15, 2011, issued on Jun. 10, 2014 as U.S. Pat. No. 8,749,620, the disclosure of which is incorporated herein by reference in its entirety.

The present application is related to U.S. Utility application Ser. No. 13/155,882 for “Storage and Transmission of Pictures Including Multiple Frames,” (Atty. Docket No. LYT009), filed Jun. 8, 2011, issued on Dec. 9, 2014 as U.S. Pat. No. 8,908,058, the disclosure of which is incorporated herein by reference in its entirety.

### TECHNICAL FIELD

The present disclosure relates to digital imaging systems and methods, and more specifically, to systems and methods for obtaining enhanced depth map information for images.

### BACKGROUND

In conventional photography, the camera must typically be focused at the time the photograph is taken. The resulting image may have only color data for each pixel; accordingly, any object that was not in focus when the photograph was taken cannot be brought into sharper focus because the necessary data does not reside in the image. Further, conventional images typically contain little or no depth information to indicate the distance between the imaging plane and the objects in the scene. Thus, if a user wishes to apply any effects that take into account the shape and/or relative positioning of objects in the scene, he or she must apply guesswork to apply such effects, often with inaccurate results even after significant trial and error.

By contrast, light-field images typically encode additional data for each pixel related to the trajectory of light rays incident to that pixel when the light-field image was taken. This data can be used to manipulate the light-field image through the use of a wide variety of rendering techniques that are not possible to perform with a conventional photograph. In some implementations, a light-field image may be refocused and/or altered to simulate a change in the center of perspective (CoP) of the camera that received the image. Further, a light-field image may be used to generate an enhanced depth-of-field (EDOF) image in which all parts of the image are in focus.

Existing techniques for obtaining depth information from light-field images or other images are limited in many respects. Specifically, such techniques often produce depth information containing discontinuities or artifacts that do not represent accurate depth information, particularly when the objects being imaged have smooth surfaces. Such inaccuracies may make it difficult, time-consuming, labor-intensive, or even impossible to conduct subsequent image processing steps that involve the shape and/or relative positioning of the objects in the scene.

### SUMMARY

According to various embodiments, the system and method described herein capture a digital image, and provide for enhanced generation of a depth map indicative of the distance between objects in the scene and the camera used to capture the image. In at least one embodiment, the system and method may project a light pattern into a scene, and capture light reflected from the projected light pattern, to generate an improved-quality depth map for the image.

More specifically, in at least one embodiment, a light pattern source may be used to project the light pattern into a scene with one or more objects. The light pattern may be regular or random. For example, the light pattern may be a grid or other array of points or lines. From the light pattern, second light may be reflected from the objects. First light originating from one or more light sources other than the light pattern source may also be reflected from the one or more objects in the scene.

A camera may be used to capture the first light and the second light, after reflection of the first light and the second light from the one or more objects. The camera may be a light-field image capture device designed to capture light and generate corresponding light-field images. The camera may have one image sensor that captures the first light and the second light, or may have separate image sensors for capture of the first light and the second light. In a processor, which may be part of the camera or part of a post-processing system connected to the camera, at least the first light may be used to generate an image such as a light-field image.

Further, in the processor, at least the second light may be used to generate a depth map indicative of distance between the one or more objects and the camera. The processor may utilize the configuration of the light pattern to more accurately ascertain the distance from the camera of each part of each of the one or more objects that is illuminated by the light pattern. Additionally or alternatively, the light pattern may help the processor ascertain the orientation of surfaces illuminated by the light pattern.

In the event that the first and second light are simultaneously captured by a single image sensor, one or more image processing steps may be performed to remove the effects of the second light from the image so that the light pattern is substantially invisible to the viewer. Such image processing steps may include the use of various processing algorithms, which may, for example, compensate for the presence of the second light in the image by removing some of the color of the second light from pixels presumed to have captured the second light.

In the alternative, it may be beneficial to capture the first light and the second light at different times, with the first light captured when the light source is inactive, so that such processing need not be carried out. The first and second light may be captured in immediate succession so that the scene is substantially unchanged between capture of the first light and capture of the second light.

As another alternative, the first light and the second light may be captured simultaneously, but the first light may be projected at a first portion of the light sensor, while the second light is projected at a second portion of the light sensor. In this manner, image processing to remove the effects of the second light from the image may also be avoided. In some embodiments, the first light may be visible light, while the second light is invisible. The second light may be infrared, ultraviolet, or may be any other form of electromagnetic radiation, or the like. For ease of nomenclature, the term “light” is used, but is intended to refer to any type of suitable electromagnetic radiation. A light filter may have a portion that permits passage of the first light onto a first portion of the image sensor, and permits passage of the second light to a second portion of the image sensor. Thus, data generated by the first portion may be used to generate the image, while data generated by the second portion may be used to generate the depth map.

Additionally or alternatively, two separate light sensors may be used, as mentioned above, to capture the first light and the second light at the same time. For example, the second light may again be invisible, while the first light is visible. The camera may include a first image sensor that receives visible light, and a second image sensor that receives invisible light. A dichroic prism or the like may be used to direct light received through the camera aperture according to its wavelength. Visible light may be directed to the first image sensor, and invisible light may be directed to the second image sensor.

If desired, a first preliminary depth map may be generated via capture of the first light. For example, the camera may be a light-field camera that captures a four-dimensional light-field indicative of not only the color of light received by each pixel, but also of the angle of incidence of light to that pixel. Such light-field information may be processed to yield a depth map for the scene. The second light may be use to generate a second preliminary depth map. The first and second depth maps may be compared to provide a depth map of greater accuracy.

These are merely examples of generation of an enhanced depth map through the projection of a light pattern into a scene. In other embodiments, such depth information may be generated in other ways. Advantageously, the depth map may be used to model the one or more objects in the scene. Such capability may facilitate further image processing, generation of animation or virtual reality experiences based on the scene, control of robotic elements in the scene, and/or the like.

### BRIEF DESCRIPTION OF THE DRAWINGS

The accompanying drawings illustrate several embodiments. Together with the description, they serve to explain the principles of the embodiments. One skilled in the art will recognize that the particular embodiments illustrated in the drawings are merely exemplary, and are not intended to limit scope.

FIG. 1 depicts a portion of a light-field image.

FIG. 2 depicts an example of an architecture for implementing the methods of the present disclosure in a light-field capture device, according to one embodiment.

FIG. 3 depicts an example of an architecture for implementing the methods of the present disclosure in a post-processing system communicatively coupled to a light-field capture device, according to one embodiment.

FIG. 4 depicts an example of an architecture for a light-field camera for implementing the methods of the present disclosure according to one embodiment.

FIG. 5 is a schematic block diagram indicating how a camera may capture first light and second light to generate an image a depth map.

FIG. 6 is a flow diagram depicting a method of generating an image and a depth map for the image, according to one embodiment.

FIGS. 7A through 7D are illustrations of a regular grid of dots, a regular non-grid array of dots, a regular grid of lines, and a regular non-grid array of lines, according to selected embodiments.

FIG. 8 is an illustration of a light filter according to one embodiment.

FIG. 9 is a side elevation view of an arrangement for directing light at first and second image sensors, according to one embodiment.

FIGS. 10A through 10D are screenshot diagrams depicting an image captured without a light pattern, a depth map corresponding to the image, an image captured with a light pattern, and a depth map corresponding to the image, respectively, according to selected embodiments.

FIGS. 11A through 11D are screenshot diagrams depicting an image captured without a light pattern, a depth map corresponding to the image, an image captured with a light pattern, and a depth map corresponding to the image, respectively, according to selected embodiments.

FIG. 12 is a screenshot diagram depicting a rendered mesh constructed through the use of the image of FIG. 11C and the depth map of FIG. 11D, according to one embodiment.

### DEFINITIONS

For purposes of the description provided herein, the following definitions are used:
Depth: a representation of distance between an object and/or corresponding image sample and a microlens array of a camera.
Depth map: a two-dimensional map corresponding to a light-field image, indicating a depth for each of multiple pixel samples within the light-field image.
Dichroic prism: a prism that directs light into one of two directions based on the frequency and/or wavelength of the light.
Disk: a region in a light-field image that is illuminated by light passing through a single microlens; may be circular or any other suitable shape.
Dots: high intensity or low intensity regions of compact shape, which shape may, but need not, be circular, square, or the like.
Extended depth of field (EDOF) image: an image that has been processed to have objects in focus along a greater depth range.
Generally annular shape: a shape that is, or approximates, a ring.
Generally circular shape: a shape that is, or approximates, a circle.
Grid: a two-dimensional arrangement with regular spacing between elements along a first direction, and regular spacing along a second direction orthogonal to the first direction.
Image: a two-dimensional array of pixel values, or pixels, each specifying a color.
Invisible light: light of a wavelength that is not visible to the typical human eye.
Light-field image: an image that contains a representation of light-field data captured at the sensor.
Light filter: an optical component that blocks, permits, and/or directs light based on the frequency and/or wavelength of the light.
Light pattern: an arrangement of light projected through a three-dimensional space with spaced apart high intensity regions and low intensity regions.
Light pattern source: a component that projects a light pattern.
Light source: a natural or artificial light emitter.
Microlens: a small lens, typically one in an array of similar microlenses.
Regular pattern: a pattern having a regularly spaced apart arrangement of high intensity regions and low intensity regions.
Visible light: light of a wavelength that is visible to the typical human eye.

In addition, for ease of nomenclature, the term “camera” is used herein to refer to an image capture device or other data acquisition device. Such a data acquisition device can be any device or system for acquiring, recording, measuring, estimating, determining and/or computing data representative of a scene, including but not limited to two-dimensional image data, three-dimensional image data, and/or light-field data. Such a data acquisition device may include optics, sensors, and image processing electronics for acquiring data representative of a scene, using techniques that are well known in the art. One skilled in the art will recognize that many types of data acquisition devices can be used in connection with the present disclosure, and that the disclosure is not limited to cameras. Thus, the use of the term “camera” herein is intended to be illustrative and exemplary, but should not be considered to limit the scope of the disclosure. Specifically, any use of such term herein should be considered to refer to any suitable device for acquiring image data.

In the following description, several techniques and methods for processing light-field images are described. One skilled in the art will recognize that these various techniques and methods can be performed singly and/or in any suitable combination with one another.

### Architecture

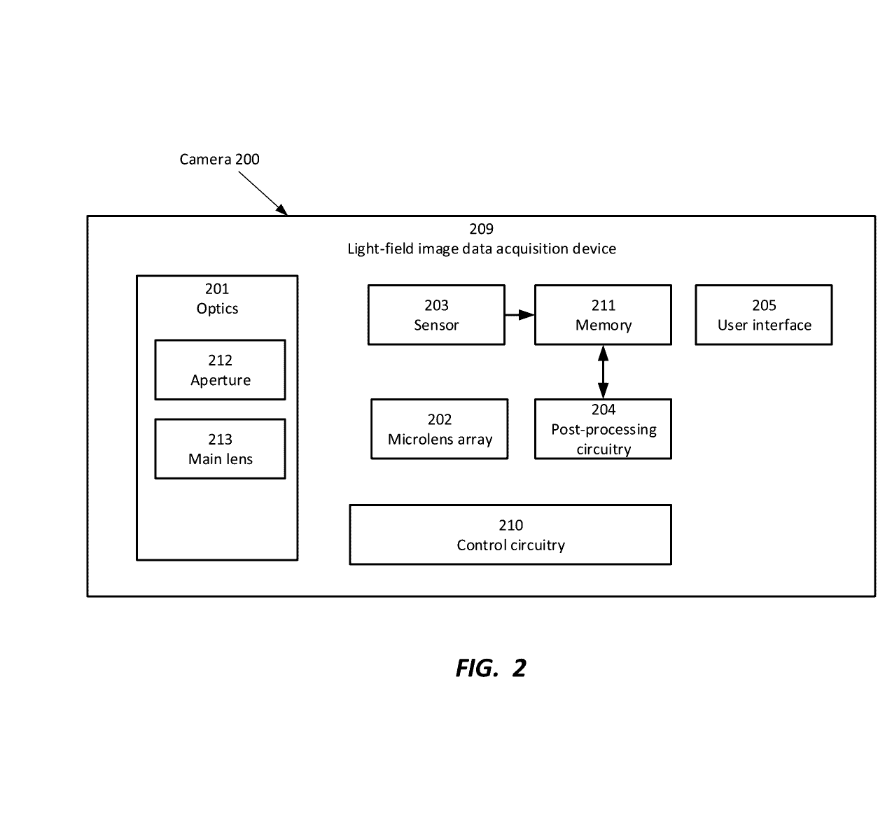

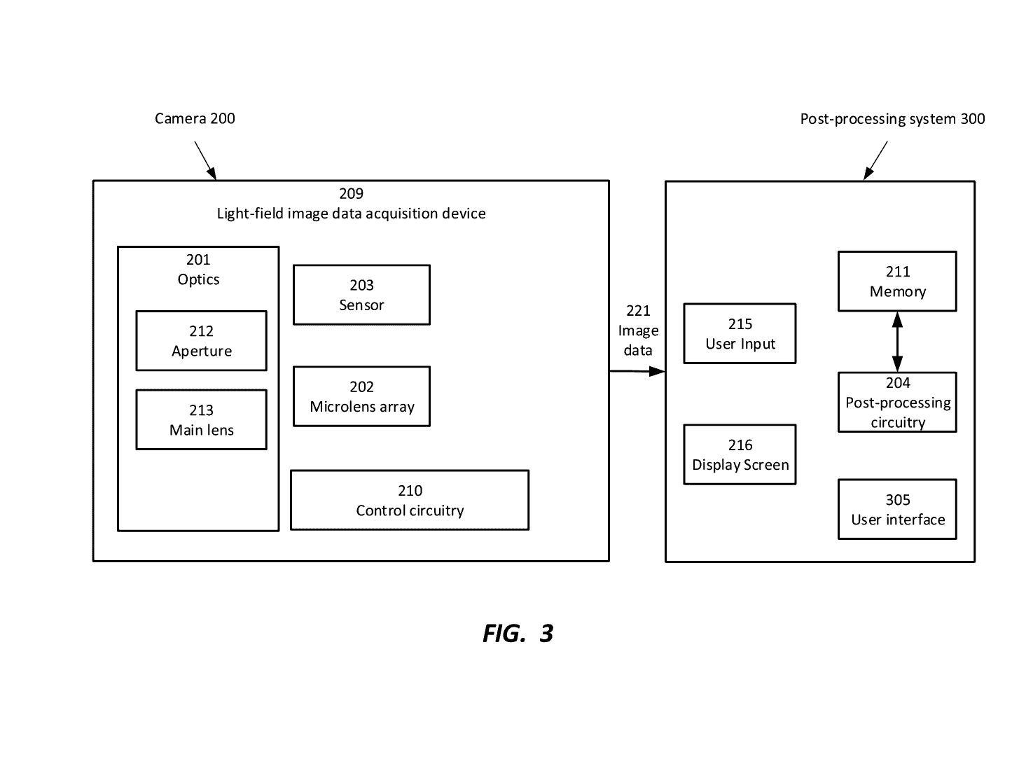

In at least one embodiment, the system and method described herein can be implemented in connection with light-field images captured by light-field capture devices including but not limited to those described in Ng et al., Light-field photography with a hand-held plenoptic capture device, Technical Report CSTR 2005-02, Stanford Computer Science. Referring now to FIG. 2, there is shown a block diagram depicting an architecture for implementing the method of the present disclosure in a light-field capture device such as a camera 200. Referring now also to FIG. 3, there is shown a block diagram depicting an architecture for implementing the method of the present disclosure in a post-processing system 300 communicatively coupled to a light-field capture device such as a camera 200, according to one embodiment. One skilled in the art will recognize that the particular configurations shown in FIGS. 2 and 3 are merely exemplary, and that other architectures are possible for camera 200. One skilled in the art will further recognize that several of the components shown in the configurations of FIGS. 2 and 3 are optional, and may be omitted or reconfigured.

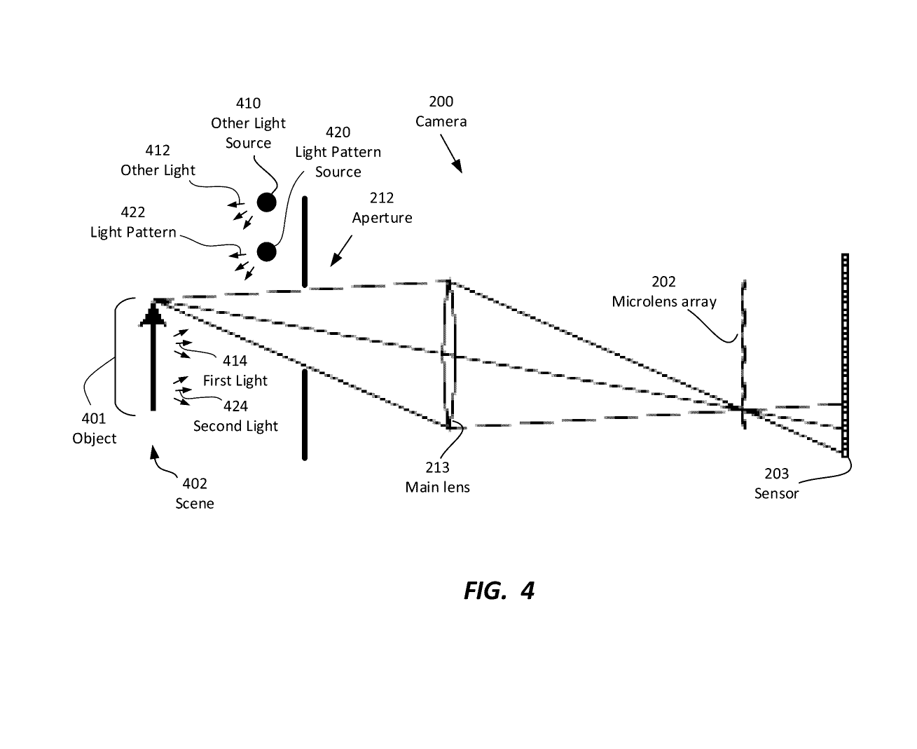

In at least one embodiment, camera 200 may be a light-field camera that includes light-field image data acquisition device 209 having optics 201, image sensor 203 (including a plurality of individual sensors for capturing pixels), and microlens array 202. Optics 201 may include, for example, aperture 212 for allowing a selectable amount of light into camera 200, and main lens 213 for focusing light toward microlens array 202. In at least one embodiment, microlens array 202 may be disposed and/or incorporated in the optical path of camera 200 (between main lens 213 and image sensor 203) so as to facilitate acquisition, capture, sampling of, recording, and/or obtaining light-field image data via image sensor 203. Referring now also to FIG. 4, there is shown an example of an architecture for a light-field camera 200 for implementing the method of the present disclosure according to one embodiment. The Figure is not shown to scale. FIG. 4 shows, in conceptual form, the relationship between aperture 212, main lens 213, microlens array 202, and image sensor 203, as such components interact to capture light-field data for one or more objects, represented by an object 401.

In at least one embodiment, light-field camera 200 may also include a user interface 205 for allowing a user to provide input for controlling the operation of camera 200 for capturing, acquiring, storing, and/or processing image data.

Similarly, in at least one embodiment, post-processing system 300 may include a user interface 305 that allows the user to provide input to control and/or activate active illumination, as set forth in this disclosure. The user interface 305 may additionally or alternatively facilitate the receipt of user input from the user to establish one or more parameters of subsequent image processing.

In at least one embodiment, light-field camera 200 may also include control circuitry 210 for facilitating acquisition, sampling, recording, and/or obtaining light-field image data. For example, control circuitry 210 may manage and/or control (automatically or in response to user input) the acquisition timing, rate of acquisition, sampling, capturing, recording, and/or obtaining of light-field image data.

In at least one embodiment, camera 200 may include memory 211 for storing image data, such as output by image sensor 203. Such memory 211 can include external and/or internal memory. In at least one embodiment, memory 211 can be provided at a separate device and/or location from camera 200.

For example, camera 200 may store raw light-field image data, as output by image sensor 203, and/or a representation thereof, such as a compressed image data file. In addition, as described in related U.S. Utility application Ser. No. 12/703,367 for “Light-field Camera Image, File and Configuration Data, and Method of Using, Storing and Communicating Same,” (Atty. Docket No. LYT3003), filed Feb. 10, 2010, memory 211 can also store data representing the characteristics, parameters, and/or configurations (collectively “configuration data”) of device 209.

In at least one embodiment, captured image data is provided to post-processing circuitry 204. The post-processing circuitry 204 may be disposed in or integrated into light-field image data acquisition device 209, as shown in FIG. 2, or it may be in a separate component external to light-field image data acquisition device 209, as shown in FIG. 3. Such separate component may be local or remote with respect to light-field image data acquisition device 209. Any suitable wired or wireless protocol can be used for transmitting image data 221 to circuitry 204; for example camera 200 can transmit image data 221 and/or other data via the Internet, a cellular data network, a WiFi network, a Bluetooth communication protocol, and/or any other suitable means.

Such a separate component may include any of a wide variety of computing devices, including but not limited to computers, smartphones, tablets, cameras, and/or any other device that processes digital information. Such a separate component may include additional features such as a user input 215 and/or a display screen 216. If desired, light-field image data may be displayed for the user on the display screen 216.

### Overview

Light-field images often include a plurality of projections (which may be circular or of other shapes) of aperture 212 of camera 200, each projection taken from a different vantage point on the camera's focal plane. The light-field image may be captured on image sensor 203. The interposition of microlens array 202 between main lens 213 and image sensor 203 causes images of aperture 212 to be formed on image sensor 203, each microlens in microlens array 202 projecting a small image of main-lens aperture 212 onto image sensor 203. These aperture-shaped projections are referred to herein as disks, although they need not be circular in shape. The term “disk” is not intended to be limited to a circular region, but can refer to a region of any shape.

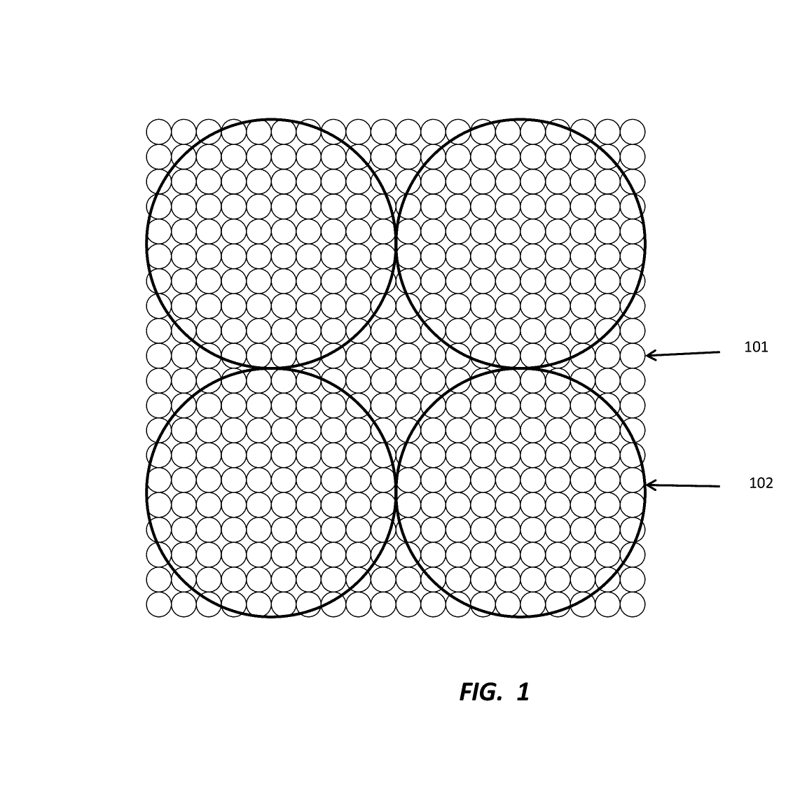

Light-field images include four dimensions of information describing light rays impinging on the focal plane of camera 200 (or other capture device). Two spatial dimensions (herein referred to as x and y) are represented by the disks themselves. For example, the spatial resolution of a light-field image with 120,000 disks, arranged in a Cartesian pattern 400 wide and 300 high, is 400×300. Two angular dimensions (herein referred to as u and v) are represented as the pixels within an individual disk. For example, the angular resolution of a light-field image with 100 pixels within each disk, arranged as a 10×10 Cartesian pattern, is 10×10. This light-field image has a 4-D (x, y, u, v) resolution of (400,300,10,10). Referring now to FIG. 1, there is shown an example of a 2-disk by 2-disk portion of such a light-field image, including depictions of disks 102 and individual pixels 101; for illustrative purposes, each disk 102 is ten pixels 101 across.

In at least one embodiment, the 4-D light-field representation may be reduced to a 2-D image through a process of projection and reconstruction. As described in more detail in related U.S. Utility application Ser. No. 13/774,971 for “Compensating for Variation in Microlens Position During Light-Field Image Processing,” (Atty. Docket No. LYT021), filed Feb. 22, 2013, the disclosure of which is incorporated herein by reference in its entirety, a virtual surface of projection may be introduced, and the intersections of representative rays with the virtual surface can be computed. The color of each representative ray may be taken to be equal to the color of its corresponding pixel.

Any number of image processing techniques can be used to reduce color artifacts, reduce projection artifacts, increase dynamic range, and/or otherwise improve image quality. Examples of such techniques, including for example modulation, demodulation, and demosaicing, are described in related U.S. application Ser. No. 13/774,925 for “Compensating for Sensor Saturation and Microlens Modulation During Light-Field Image Processing” (Atty. Docket No. LYT019), filed Feb. 22, 2013, the disclosure of which is incorporated herein by reference.

In particular, processing may utilize depth information for the image. Such depth information may take the form of a depth map, which may be a grayscale image in which each pixel has an intensity that indicates the distance from the camera of the corresponding pixel of the image. The depth map may be obtained, with limited accuracy, from the light-field data alone by comparing features present in the data captured by multiple microlenses of the microlens array 202. This comparison may be used to obtain depth information via triangulation and/or other techniques. However, as mentioned previously, this depth information may be of limited accuracy, particularly when the depth of smooth, textureless objects is to be assessed.

### Light Pattern Projection

A depth map for a light-field image may advantageously be generated to indicate the depth of objects in the image from the image sensor 203. In some embodiments, the depth map may be enhanced via projection of a light pattern onto the objects of the scene (where “light” may refer to any form of electromagnetic radiation, whether visible or invisible to the human eye).

For example, referring again to FIG. 4, the object 401 may be part of a scene 402. One or more additional objects (not shown) may be present in the scene in addition to the object 401. The scene 402 may be illuminated by light from various light sources. For example, one or more other light sources 410 may project other light 412 into the scene 402, and a light pattern source 420 may project a light pattern 422 into the scene 402. The one or more other light sources 410 may include natural and/or man-made light sources of any type known for use in illumination of objects to be imaged. The other light 412 may advantageously include visible light that can be accurately captured by the image sensor 203. Such visible light may optionally include light of any known color.

The light pattern source 420 may be a light emitting device such as a laser, incandescent, fluorescent, or LED light, which may emit the light pattern 422. The light pattern may be provided through the utilization of multiple light sources, such as an array of lasers. Additionally or alternatively, the light pattern may be provided via one or more masks positioned between the light emitter of the light pattern source 420 and the scene 402. The one or more masks may be transparent and/or translucent only within the pattern, and may be opaque to light projection outside of the pattern.

In some embodiments, the light pattern 422 may include light outside the visible spectrum (i.e., light with wavelengths above and/or below the wavelengths of light that are humanly visible). Further, the light pattern 422 may include only light outside the visible spectrum. For example, the light pattern 422 may include only infrared and/or ultraviolet light. Usage of invisible light in the light pattern 422 may help avoid alteration of the appearance of the scene 402, as captured by the camera 200.

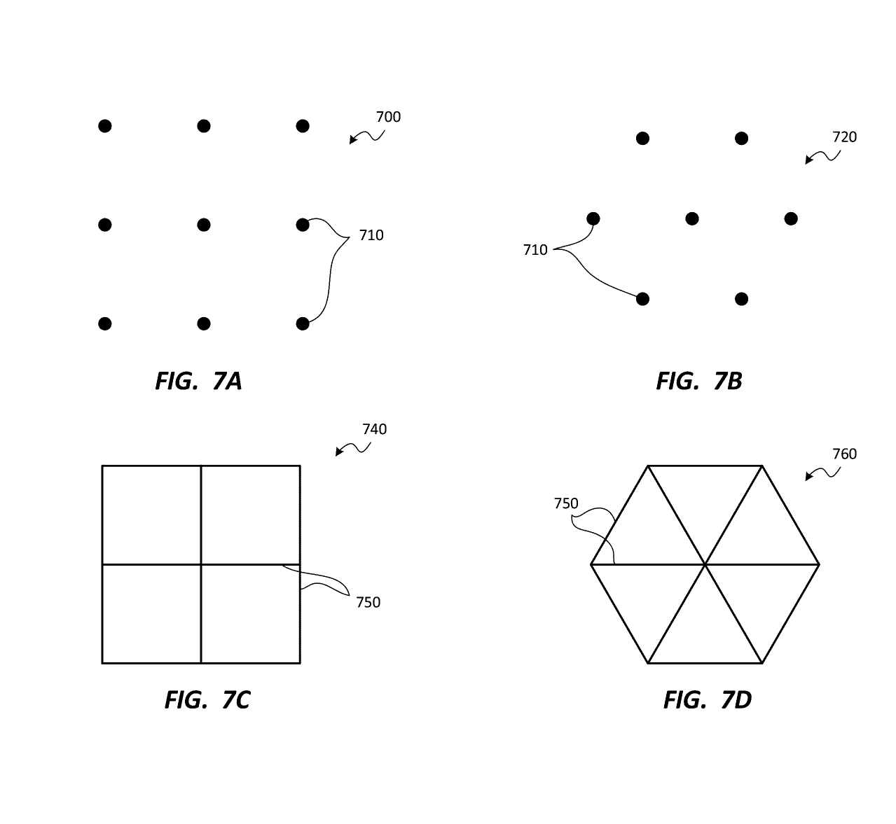

The light pattern 422 may be regular or irregular. The phrases “light pattern” and “regular pattern” are defined above. An “irregular pattern” may be a light pattern that is not a regular pattern. Various examples of regular patterns will be shown and described subsequently, in connection with FIGS. 7A through 7D.

The other light 412 and the light pattern 422 may be projected at the scene 402, and may illuminate the object 401 and/or any other object(s) present in the scene 402. The other light 412 may reflect from the scene 402 toward the camera 200 as first light 414, and the light pattern 422 may reflect from the scene 402 toward the camera 200 as second light 424. The first light 414 and the second light 424 may both be captured by the image sensor 203, if desired. In alternative embodiments, the first light 414 and the second light 424 may be captured by separate sensors and/or by separate parts of a sensor such as the image sensor 203 of FIG. 4.

FIG. 4 represents only one embodiment of a camera that may be used to practice the system and method of the invention. The camera 200 is a light-field camera with the microlens array 202 positioned to enable the image sensor 203 to gather light-field data. However, in alternative embodiments, different camera types may be used. In some embodiments, a stereoscopic camera, multiscopic camera, or the like may be used.

### Depth Map Generation

A light-field camera such as the camera 200 of FIG. 4 may optionally be used to generate a depth map for an image, independently of the use of a light pattern such as the light pattern 422 of FIG. 4. This may be done by utilizing the four-dimensional properties of light-field images. More specifically, since the disks 102 capture information regarding the origin of light-rays captured by the image sensor 203, this information may be used to estimate the depth at which various portions of the light-field image are positioned from the image sensor 203. Usage of the light pattern 422 may advantageously enable the generation of a more accurate depth map, as will be shown and described subsequently. Usage of the light pattern 422 may be particularly helpful for textureless objects or surfaces; projecting the light pattern 422 onto the object may simulate texture on the object to provide for more accurate depth map generation.

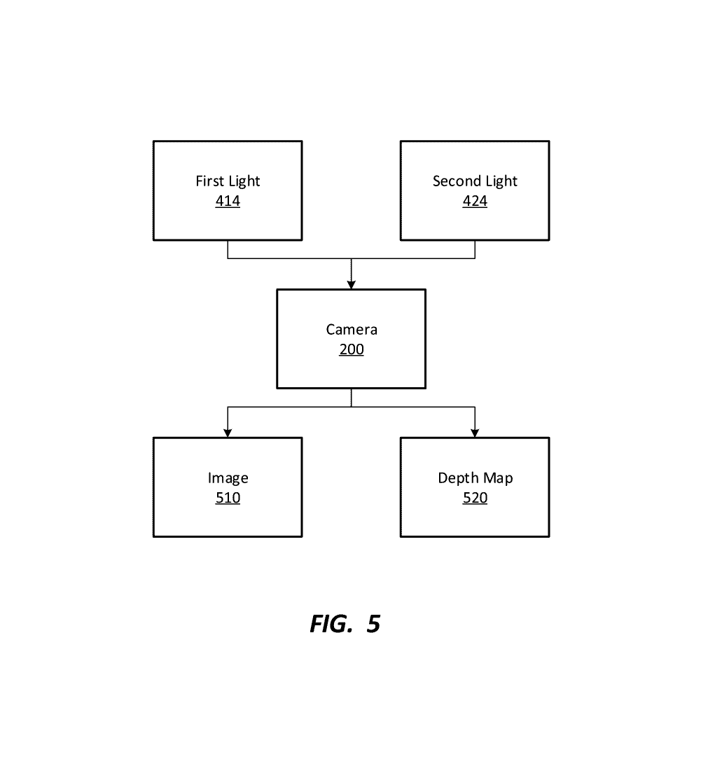

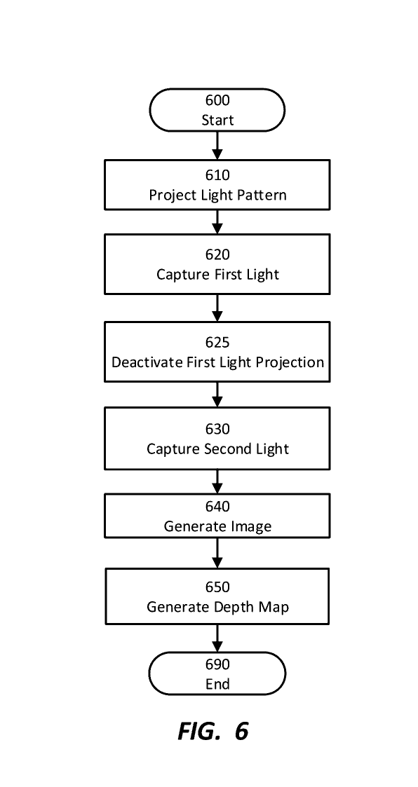

As indicated previously, a light-field camera need not necessarily be used to carry out the system and method of the present disclosure. The light-field camera 200 of FIG. 4 will be referenced in the description of FIGS. 5 and 6 by way of example. Those of skill in the art will recognize that the following descriptions may be readily adapted to other camera types.

FIG. 5 is a schematic block diagram indicating how a camera such as the camera 200 of FIG. 4 may capture the first light 414 and the second light 424 to generate an image and a depth map. Specifically, the camera 200 may capture the first light 414 and the second light 424. The camera 200 may use at least the first light 414 to generate an image 510 depicting the scene 402. Further, the camera 200 may use at least the second light 424 to generate a depth map 520 indicating the depth at which the object 401 (and one or more additional objects in the scene 402, as applicable) is positioned relative to the camera 200 (or more specifically, relative to a component of the camera 200 such as the image sensor 203 and/or the microlens array 202).

The depth map 520 may correspond to the image 510, and may thus indicate the depth of objects within the scene 402, as bounded by the edges of the image 510. If desired, the depth map 520 may take the form of an image, which may be in grayscale. Increasing intensity levels in such an image may be used to indicate increasing depth, or alternatively, to indicate decreasing depth. Optionally, the second light 424 may also be used in the generation of the image 510 and/or the first light 414 may be used in the generation of the depth map 520.

FIG. 6 is a flow diagram depicting a method of generating an image and a depth map for the image, according to one embodiment. The method may be performed, for example, with circuitry such as the post-processing circuitry 204 of the camera 200 of FIG. 2 or the post-processing circuitry 204 of the post-processing system 300 FIG. 3, which is independent of the camera 200. In some embodiments, a computing device may carry out the method; such a computing device may include one or more of desktop computers, laptop computers, smartphones, tablets, cameras, and/or other devices that process digital information.

The method may start 600 with a step 610 in which the light pattern 422 is projected into the scene 402. This may be done by activating a light pattern source such as the light pattern source 420 of FIG. 4. If needed, the light pattern source 420 may be oriented such that the light pattern 422 is projected into the scene 402 in a manner that enables the light pattern 422 to impinge against one or more selected objects within the scene 402. Alternatively, the light pattern 422 may have a sufficiently broad projection and depth of projection to impinge against all objects within the scene 402. If desired, the light pattern source 420 may be secured to the camera 200 in such a manner that the light pattern source 420 is always oriented to project the light pattern 422 into a region with a size and shape that generally corresponds to the size and shape of the field of view of the camera 200.

The step 610 may entail activation of the light pattern source 420 for a prolonged period of time. Alternatively, the light pattern source 420 may only be activated for the duration of image capture, or for a slightly longer duration to ensure that the scene 402 is illuminated with the light pattern 422 for the entire duration of image capture. For example, the light pattern source 420 may be connected to the camera 200 such that, when the user initiates image capture, the light pattern source 420 is activated and remains active for at least the duration of image capture. Alternatively, the light pattern source 420 may be configured such that, when the user initiates image capture, the light pattern source 420 is activated for only a portion of the duration of image capture. Thus, the light pattern source 420 may operate in a manner similar to that of the flash on a conventional camera.

In a step 620, the first light 414 may be captured, for example, by the image sensor 203 of the camera 200. For a camera such as the light-field camera 200 of FIG. 4, capture of the first light 414 may result in the generation of image data 221 in the form of light-field data. The captured light-field data may be received in a computing device, which may be the camera 200 as in FIG. 2. Alternatively, the computing device may be separate from the camera 200 as in FIG. 3, and may be any type of computing device, including but not limited to desktop computers, laptop computers, smartphones, tablets, and the like.

In a step 625, the light pattern source 420 may be deactivated. As mentioned previously, this step may not be needed, depending on whether the light pattern 422 is to be projected during capture of the second light 424. In some embodiments, capture of the first light 414 may be substantially simultaneous with capture of the second light 424. In such embodiments, the light pattern source 420 may remain active during capture of the first light 414 and capture of the second light 424.

In a step 630, the second light 424 may be captured, for example, by the image sensor 203 of the example camera 200. As indicated previously, the second light 424 may optionally contribute to the image data 221. Alternatively, the second light 424 may be used only for the generation of the depth map 520. In the event that the second light 424 is captured by a sensor adjacent to a microlens array 202, such as the image sensor 203 of the camera 200 of FIG. 4, capture of the second light 424 may also result in the generation of light-field data. Such light-field data may be received in a computing device, as with the light-field data resulting from capture of the first light 414.

In a step 640, the image 510 may be generated. This may be done by processing the light-field data received via capture of the first light 414. If the step 620 and the step 630 are performed simultaneously with a single image sensor such as the image sensor 203 of the camera 200 of FIG. 4, the light-field data received via capture of the first light 414 may be commingled with that received via capture of the second light 424. Thus, data from the second light 424 may also be processed and incorporated into the image 510. However, in alternative embodiments, the first light 414 and the second light 424 may be captured at separate times, by separate sensors, and/or by separate parts of a single sensor so that the effects of the second light 424 need not appear in the image 510.

In a step 650, the depth map 520 may be generated. This may be done by processing the light-field data received via capture of the second light 424. If the light pattern 422 is a regular pattern, the spacing of elements of the light pattern 422 may reveal the distance at which an object is positioned from the example camera 200. Variation (or lack of variation) in such spacing may reveal the orientation of a surface of the object. Such information may be processed by a processor, such as the post-processing circuitry 204 of the example camera 200 of FIG. 2, or the post-processing circuitry 204 of the post-processing system 300 of FIG. 3. An irregular pattern may similarly be processed to yield distance and/or orientation information; the (irregular) spacing between elements of such a pattern may be received in the processor and taken into account as the depth map 520 is generated.

In some embodiments, the step 650 may include the generation of multiple depth maps. For example, as mentioned previously, usage of light-field data (such as data received from capture of the first light 414) alone may permit the generation of a depth map. If desired, a first preliminary depth map may be generated based on the light-field data generated from capture of the first light 414. A second preliminary depth map may be generated based on the data generated by capture of the second light 424. The second preliminary depth map may utilize the light pattern 422 as described above. Then, the first and second preliminary depth maps may be compared with each other to yield a finalized depth map. In some embodiments, comparison of multiple preliminary depth maps may facilitate noise reduction, identification of false depth artifacts, and the like. Thus, the finalized depth map may be more accurate than either of the preliminary depth maps.

Once the step 640 and the step 650 have been carried out, the method may end 690. The depth map 520 may then be used in further processing of the image 510, for example, to generate a three-dimensional model of one or more objects in the scene captured in the image 510, to carry out depth-based image processing, or the like.

The method of FIG. 6 is only one of many possible methods that may be used to generate an image and a corresponding depth map. According to various alternatives, various steps of FIG. 6 may be carried out in a different order, omitted, and/or replaced by other steps. Notably, for a camera that is not a light-field camera, the steps of FIG. 6 may be carried out in a manner similar to that described above, except that the data generated from capture of the first light 414 and the second light 424 will not be light-field data. If the camera is stereoscopic, multiscopic, or otherwise is capable of receiving images from multiple viewpoints, the first light 414, alone, may be used to generate a first preliminary depth map by triangulating the position of common points in the images received. The final depth map may then, again, be obtained by comparing the first preliminary depth map with a second preliminary depth map generated from the data received from capture of the second light 424.

The method of FIG. 6 may be usable with a wide variety of regular and irregular light patterns. Although irregular light patters may be used as described above, the use of regular light patterns may reduce computational requirements. A variety of regular light patterns will be shown and described in connection with FIGS. 7A through 7D, as follows.

### Regular Light Patterns

FIGS. 7A through 7D are illustrations of a regular grid of dots, a regular non-grid array of dots, a regular grid of lines, and a regular non-grid array of lines, according to selected embodiments. These embodiments are merely examples of regular light patterns that may be used within the scope of the present disclosure; those of skill in the art will recognize that a wide variety of regular light patterns may be used besides those shown in FIGS. 7A through 7D.

FIG. 7A illustrates a light pattern 700 in the form of a regular grid of dots 710. As indicated in the definitions set forth above, a “dot” need not be circular in shape, like the dots 710 of FIG. 7A, but may have any compact shape, including but not limited to circles, squares, and the like. As shown, the dots 710 define a grid shape with regular spacing between rows and columns.

FIG. 7B illustrates a light pattern 720 in the form of a regular non-grid array of dots 710. As shown, the dots 710 define an array with multiple rows that are spaced apart at regular intervals; however, the dots 710 are not arranged in continuous columns.

FIG. 7C illustrates a light pattern 740 in the form of a regular grid of lines 750. As shown, the lines 750 define a grid shape with regular spacing between rows and columns, in a manner similar to that of the dots 710 of FIG. 7A.

FIG. 7D illustrates a light pattern 760 in the form of a regular non-grid array of lines 750. As shown, the lines 750 define an array with multiple rows that are spaced apart at regular intervals; however, the lines 750 are not arranged in continuous columns. The arrangement of the lines 750 of the light pattern 760 of FIG. 7D may thus be similar to that of the dots 710 of the light pattern 720 of FIG. 7B.

FIGS. 7A through 7D represent the dots 710 and the lines 750 in black, with the surrounding areas in white. However, in alternative embodiments, light dots or lines may be used, with dark surroundings. Additionally or alternatively, a light pattern may include gradations of intensity (for example, with elements projected in high intensity light, other elements projected in lower intensity light, and some portions that receive no light).

As indicated previously, the second light 424 reflected from the light pattern 422 may be captured simultaneously with capture of the first light 414 reflected from the light 412 from the other light sources 410. If this is done using the same sensor (for example, the image sensor 203 of the camera 200 of FIG. 4), and the light pattern 422 includes visible light, undesired effects of the light pattern 422 may appear in the image 510. Thus, it may be desirable to process the image 510 to remove the effects of the light pattern 422. This may be accomplished according to a variety of methods.

For example, if the light pattern 422 has a fixed, known relationship relative to the camera 200, the processor (for example, the post-processing circuitry 204 of FIG. 2 and/or the post-processing circuitry 204 of the post-processing system 300 of FIG. 3) may apply color correction to the locations of the image 510 that are known to be affected by the light pattern 422. Alternatively, if the light pattern 422 utilizes a color that is not likely to occur elsewhere in the image 510, the processor may apply color correction to remove effects of the color of the light pattern 422 from the image 510.

In alternative embodiments, the first light 414 may be captured at a different time from capture of the second light 424. For example, the camera 200 may capture the first light 414, activate the light pattern source 420 to emit the light pattern 422, and then capture the second light 424 after capture of the first light 414 has been completed. Then, only the first light 414 may be used to generate the image 510, and only the second light 424 may be used to generate the depth map 520.

Advantageously, in such an embodiment, the image 510 may not include any effects from the light pattern 422, since the light pattern 422 was not being projected into the scene 402 at the time the first light 414 was captured. Thus, there may be no need to process the image 510 to remove effects of the light pattern 422. If capture of the first light 414 and capture of the second light 424 are performed in relatively rapid succession, there may be little or no motion of the objects in the scene 402 relative to the camera, between the two capture steps. Such a method may be performed with a camera having a single sensor, like the camera 200 of FIG. 4.

In other alternative embodiments, the first light 414 and the second light 424 may be captured simultaneously, but by different sensors, or by different portions of a single sensor. Again, in such embodiments, only the first light 414 may be used to generate the image 510, and only the second light 424 may be used to generate the depth map 520. Such embodiments may also have the advantage of having no need to process the image 510 to remove effects of the light pattern 422.

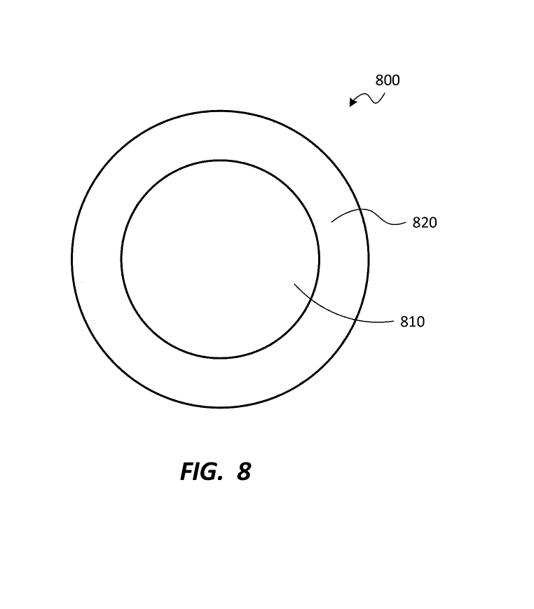

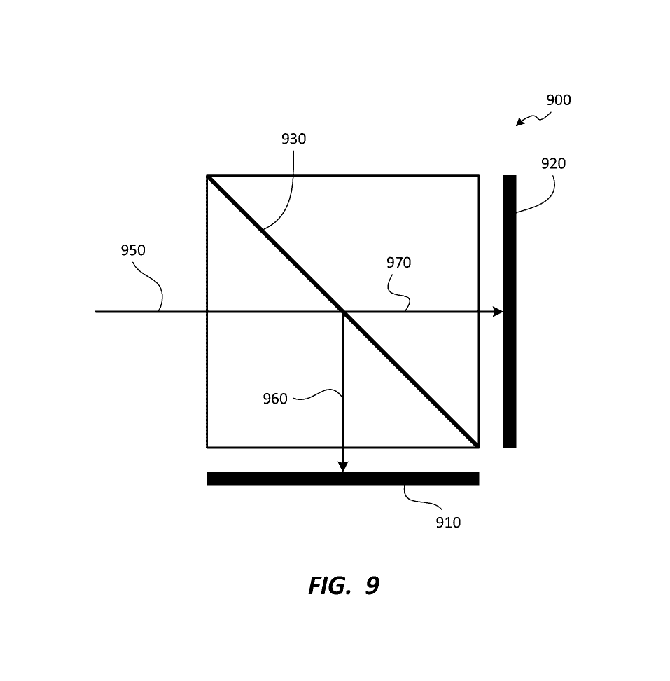

Implementation of such embodiments may be facilitated where the light pattern 422 includes light within a frequency range distinct from that of the other light 412. Since the other light 412 likely includes visible light, it may be advantageous to use invisible light, such as ultraviolet and/or infrared light, for the light pattern 422. Then, various optical components may be used to separate the visible light from the invisible light so the first light 414 and the second light 424 can be separated from each other for capture. Exemplary embodiments of utilizing such optical components will be shown and described in connection with FIGS. 8 and 9, as follows.

### Visible and Invisible Light Capture

FIG. 8 is an illustration of a light filter 800 according to one embodiment. The light filter 800 may facilitate simultaneous capture of visible and invisible light with a single image sensor in a manner that facilitates differentiation between the visible light and the invisible light. The light filter 800 may be positioned proximate the aperture of a camera, such as the camera 200 of FIG. 4. If desired, the light filter 800 may take the place of a UVIR filter elsewhere in the camera 200, which may ordinarily be positioned proximate the image sensor 203.

As shown, the light filter 800 may have a central portion 810 that does not permit passage of invisible light, such as ultraviolet and/or infrared light. Further, the light filter 800 may have a peripheral portion 820 that permits passage of invisible light of the frequency used in the light pattern 422. Thus, for example, the peripheral portion 820 may be permeable to infrared or ultraviolet light. The light filter 800 may be used in conjunction with a single sensor of a type capable of detecting visible light and invisible light of the wavelength used in the light pattern 422.

Hence, the light filter 800 may project the first light 414 toward the sensor (for example, the image sensor 203 of the light-field camera 200 of FIG. 4) in a generally circular shape. Further, the light filter 800 may project the second light 424 toward the image sensor 203 in a generally annular shape that surrounds the first light 414 projected toward the image sensor 203. The generally annular shape may have an interior diameter sized such that the first light 414 projected toward the image sensor 203 fits within the second light 424 projected toward the image sensor 203.

The image sensor 203 may include a first portion that receives the first light 414 and a second portion that receives the second light 424. In this example, the first portion may have a generally circular shape at the interior of the image sensor 203, and the second portion may have a generally annular shape that fits around the first portion.

The first portion and the second portion of the image sensor 203 may have different compositions and/or structures that are optimized capture of visible light by the first portion and capture of invisible light by the second portion. Alternatively, the first portion and the second portion may have substantially the same configuration, in which the first portion and the second portion are both able to capture visible light and invisible light of the frequency range(s) used in the light pattern 422. The processor (for example, the post-processing circuitry 204 of FIG. 2 or FIG. 3) may ascertain that captured light is visible or invisible based on the location of the pertinent portion of the image sensor 203 (i.e., whether the light was captured by the first portion or the second portion of the image sensor 203).

Advantageously, the depth map 520 may be generated from the rays of light having the largest angular diversity (i.e., rays passing through the peripheral portion 820 of the light filter 800). This may lead to more accurate depth estimates, thus enabling higher accuracy of the depth map 520. Further, the usage of rays passing through the central portion 810 of the light filter 800 to generate the image 510 may also be advantageous. For example, light rays of less angular diversity may lead to the generation of higher quality extended depth of field (EDOF) images.

As another advantage, the image 510 may be produced using only the data received from capture of the first light 414 (i.e., the data captured by the first portion of the image sensor 203). Thus, the image 510 may not need to be processed to remove any effects from the light pattern 422.

In at least one embodiment, the light filter 800 is implemented using an image sensor that is capable of capturing ray angle information, i.e., a light-field. Further, a microlens array, such as the microlens array 202 of FIG. 2, may used in order to properly differentiate the first light 414 from the second light 424 based on the angle of incidence of the light captured by the image sensor 203.

In alternative embodiments, separate images sensors may be used for visible and invisible light. One such embodiment will be shown and described in connection with FIG. 9.

FIG. 9 is a side elevation view of an arrangement for directing light at a first image sensor 910 and a second image sensor 920, according to one embodiment. The arrangement may include a dichroic prism 900, which may have an interface 930 at which incoming light 950 is divided into visible light 960 and invisible light 970. More specifically, the incoming light 950 may impinge on the interface 930, and the portion of the incoming light 950 that is the visible light 960 may reflect off of the interface 930, for example, at an angle of 90°, as shown. Conversely, the portion of the incoming light 950 that is the invisible light 970 may pass through the interface 930.

The incoming light 950 may include both the first light 414 and the second light 424. The first light 414 may be directed by the dichroic prism 900 toward the first image sensor 910 (as the visible light 960), and the second light 424 may be directed by the dichroic prism 900 toward the second image sensor 920 (as the invisible light 970). Thus, the first image sensor 910 may capture the first light 414 and the second image sensor 920 may capture the second light 424, substantially simultaneously with capture of the first light 414.

If desired, a microlens array (not shown in FIG. 9) such as the microlens array 202 of FIG. 4 may be positioned between the dichroic prism 900 and the first image sensor 910 and/or the second image sensor 920. Thus, the dichroic prism 900 may be used to generate light-field data that can be used in the generation of the image 510 and/or the depth map 520. Further, if desired, the first image sensor 910 may be of a type designed to capture only visible light, and the second image sensor 920 may be of a type designed to capture only invisible light of the wavelength(s) used in the light pattern 422. If desired, one or more filters may be used in conjunction with the first image sensor 910 and/or the second image sensor 920 to ensure that only the desired type of light is received by each of the first image sensor 910 and the second image sensor 920.

As in the embodiment of FIG. 8, the image 510 may advantageously be produced using only the data received from capture of the first light 414. This may be done by using only the data captured by the first image sensor 910 to generate the image 510. Thus, the image 510 may not need to be processed to remove any effects from the light pattern 422. The light pattern 422 may be arbitrary, and the location of the light pattern source 420 may also be arbitrary, thus removing some of the far distance constraints that may be found in other embodiments.

Further, the embodiment of FIG. 9 may advantageously provide for higher quality imaging due to the collection of more photons, and the ability to independently optimize each of the first image sensor 910 and the second image sensor 920. Additionally, the embodiment of FIG. 9 permits the use of conventional lenses (that lack the light filter 800), and also permits the use of conventional image capture systems, such as conventional captures (i.e., cameras that are not light-field cameras). However, the embodiment of FIG. 8 may provide some advantages related to simplicity, compactness, and ease of manufacturing.

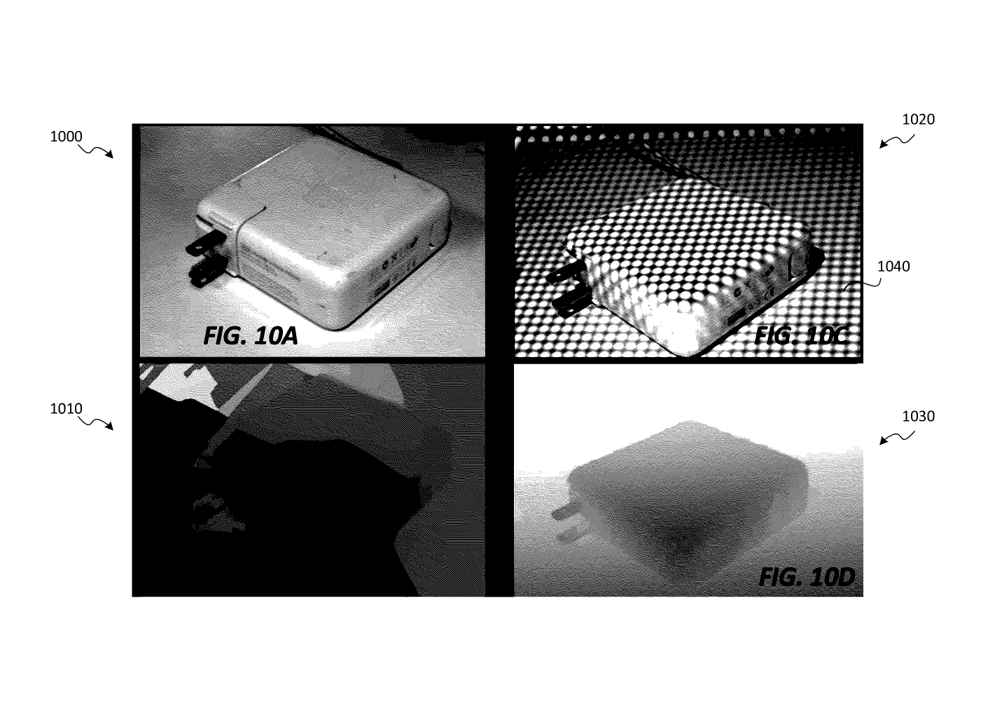

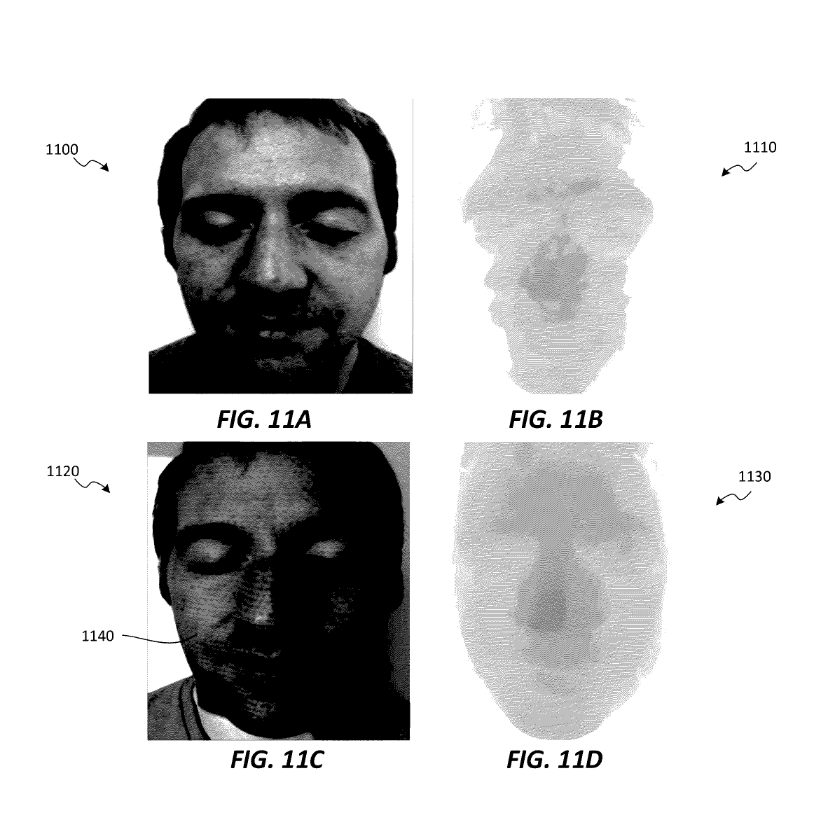

Those of skill in the art will recognize that a wide variety of optical components besides the light filter 800 of FIG. 8 and the dichroic prism 900 of FIG. 9 may be used to separate and/or direct light to facilitate the generation of images and/or depth maps according to the present disclosure. Various examples of images and depth maps produced using the systems and methods of the present disclosure will be shown and described in connection with FIGS. 10A through 11D, as follows.

### Exemplary Images and Depth Maps

FIGS. 10A through 10D are screenshot diagrams depicting an image 1000 captured without a light pattern, a depth map 1010 corresponding to the image 1000, an image 1020 captured with a light pattern 1040, and a depth map 1030 corresponding to the image 1020, respectively, according to selected embodiments. The image 1000, the depth map 1010, the image 1020, and the depth map 1030 are of a power adapter with a relatively smooth, untextured surface that may present challenges for depth map generation.

FIG. 10A illustrates the image 1000, which is in grayscale. FIG. 10B illustrates the depth map 1010 for the image, which is also in grayscale, with darker portions relatively closer to the camera 200 than lighter portions. As shown, the body of the power adapter does not show a gradual increase in depth toward the far corner, as would be expected. Rather, there are some unexpected discontinuities and artifacts present, and the depth map 1010 does not accurately represent depth information for the scene, limiting its usefulness in subsequent depth-based processing of the image.

FIG. 10C illustrates the image 1020, which is in grayscale, with a light pattern 1040 like that of FIG. 7C projected into the image 1020 so as to alleviate the problems seen in the examples of FIGS. 10A and 10B. As shown in FIG. 10C, the light pattern 1040 adds visible texture to the surfaces of the power adapter, facilitating more accurate depth assessment. FIG. 10D illustrates the depth map 1030 that corresponds to the image 1020. As shown, the depth map 1030 is relatively continuous along the surfaces of the power adapter, showing a gradient indicative of gradually increasing depth toward the far corner of the power adapter. Features of the power adapter such as the prongs are relatively distinct. There are no significant artifacts. Thus, this depth map 1030 is better suited to facilitate depth-based processing of the image 1020, generation of a three-dimensional model of the power adapter, and/or the like.

FIGS. 11A through 11D are screenshot diagrams depicting an image 1100 captured without a light pattern, a depth map 1110 corresponding to the image 1100, an image 1120 captured with a light pattern 1140, and a depth map 1130 corresponding to the image 1120, respectively, according to selected embodiments. The image 1100, the depth map 1110, the image 1120, and the depth map 1130 are of a human face, illustrating the ability of the system and method of the present disclosure to generate accurate depth information for more complex objects.

FIG. 11A illustrates the image 1100, which is in color. FIG. 11B illustrates the depth map 1110 for the image, which is in grayscale, with darker portions relatively closer to the camera 200 than lighter portions. As in the depth map 1010 of FIG. 10B, the face does not show a gradual increase in depth toward the sides of the face, as would be expected. Rather, unexpected discontinuities and artifacts are present in the depth map 1110; once again, depth map 1110 does not accurately represent depth information for the scene, limiting its usefulness in subsequent depth-based processing of the image.

FIG. 11C illustrates the image 1120, which is also in color, with a light pattern 1140 like that of FIG. 7A projected into the image 1120 so as to alleviate the problems seen in the examples of FIGS. 11A and 11B. As shown in FIG. 11C, the light pattern 1140 adds visible texture to the surfaces of the face, facilitating more accurate depth assessment. FIG. 11D illustrates the depth map 1130 that corresponds to the image 1120. As in FIG. 10D, the depth map 1130 is relatively continuous, showing a gradient indicative of gradually increasing depth toward the sides of the face. Features of the face such as the nose and hair are more distinct, and lack the artifacts of the depth map 1110 of FIG. 11B.

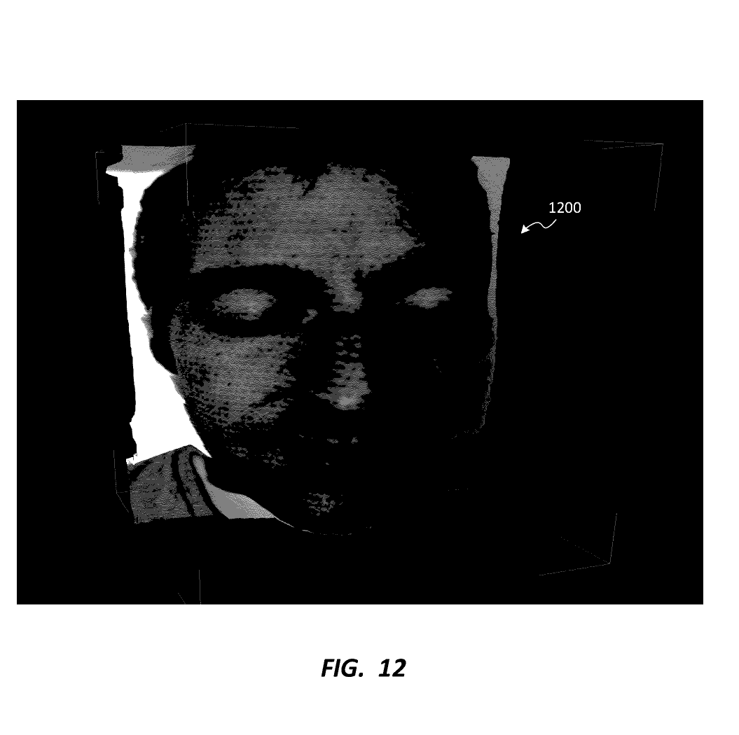

Thus, this depth map 1130 is better suited to facilitate depth-based processing of the image 1020, generation of a three-dimensional model of the face, and/or the like. By way of further example, a three-dimensional model of the face, generated through the use of the image 1120 and the depth map 1130, will be shown in FIG. 12.

FIG. 12 is a screenshot diagram depicting a rendered mesh 1200 constructed through the use of the image 1120 of FIG. 11C and the depth map 1130 of FIG. 11D, according to one embodiment. The rendered mesh 1200 may constitute a three-dimensional model of the face, with the image 1120 applied as a texture. The accuracy of the depth map 1130 contributes significantly to the quality of the rendered mesh 1200. Advantageously, through the system and method of the present disclosure, three-dimensional models of imaged objects (or at least the portions that face toward the camera 200) may be generated with little or no human involvement. This capability has great potential in the fields of robotics, surgical navigation, film and video game production, and the like.

As indicated previously, a relatively accurate depth map can also be used to process an image based on the depth of objects from the camera. For example, effects may be applied, with variable application based on the depth of the object or surface from the camera. As one example, a background of an image may be replaced with a different background without requiring the user to specifically delineate which portions of the image pertain to the background to be replaced, and which portions pertain to foreground objects.

The above description and referenced drawings set forth particular details with respect to possible embodiments. Those of skill in the art will appreciate that the techniques described herein may be practiced in other embodiments. First, the particular naming of the components, capitalization of terms, the attributes, data structures, or any other programming or structural aspect is not mandatory or significant, and the mechanisms that implement the techniques described herein may have different names, formats, or protocols. Further, the system may be implemented via a combination of hardware and software, as described, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

Some embodiments may include a system or a method for performing the above-described techniques, either singly or in any combination. Other embodiments may include a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions of described herein can be embodied in software, firmware and/or hardware, and when embodied in software, can be downloaded to reside on and be operated from different platforms used by a variety of operating systems.

Some embodiments relate to an apparatus for performing the operations described herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, flash memory, solid state drives, magnetic or optical cards, application specific integrated circuits (ASICs), and/or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the techniques set forth herein are not described with reference to any particular programming language. It will be appreciated that a variety of programming languages may be used to implement the techniques described herein, and any references above to specific languages are provided for illustrative purposes only.

Accordingly, in various embodiments, the techniques described herein can be implemented as software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or nonportable. Examples of electronic devices that may be used for implementing the techniques described herein include: a mobile phone, personal digital assistant, smartphone, kiosk, server computer, enterprise computing device, desktop computer, laptop computer, tablet computer, consumer electronic device, television, set-top box, or the like. An electronic device for implementing the techniques described herein may use any operating system such as, for example: Linux; Microsoft Windows, available from Microsoft Corporation of Redmond, Wash.; Mac OS X, available from Apple Inc. of Cupertino, Calif.; iOS, available from Apple Inc. of Cupertino, Calif.; Android, available from Google, Inc. of Mountain View, Calif.; and/or any other operating system that is adapted for use on the device.

In various embodiments, the techniques described herein can be implemented in a distributed processing environment, networked computing environment, or web-based computing environment. Elements can be implemented on client computing devices, servers, routers, and/or other network or non-network components. In some embodiments, the techniques described herein are implemented using a client/server architecture, wherein some components are implemented on one or more client computing devices and other components are implemented on one or more servers. In one embodiment, in the course of implementing the techniques of the present disclosure, client(s) request content from server(s), and server(s) return content in response to the requests. A browser may be installed at the client computing device for enabling such requests and responses, and for providing a user interface by which the user can initiate and control such interactions and view the presented content.

Any or all of the network components for implementing the described technology may, in some embodiments, be communicatively coupled with one another using any suitable electronic network, whether wired or wireless or any combination thereof, and using any suitable protocols for enabling such communication. One example of such a network is the Internet, although the techniques described herein can be implemented using other networks as well.

While a limited number of embodiments has been described herein, those skilled in the art, having benefit of the above description, will appreciate that other embodiments may be devised which do not depart from the scope of the claims. In addition, it should be noted that the language used in the specification has been principally selected for readability and instructional purposes, and may not have been selected to delineate or circumscribe the inventive subject matter. Accordingly, the disclosure is intended to be illustrative, but not limiting.

What is claimed is:

1. A method for capturing an image and generating a depth map for the image, the method comprising:
with a light pattern source, projecting a light pattern into a scene comprising one or more objects;
in a camera, capturing first light reflected from the one or more objects, wherein the first light comprises a reflection of light originating from one or more other light sources independent of the light pattern source;
in the camera, capturing second light reflected from the one or more objects, wherein the second light comprises a reflection of the light pattern from the one or more objects;
in a processor, using at least the first light to generate the image, wherein the image depicts the scene; and
in the processor, using at least the second light to generate a depth map indicative of distance between the one or more objects and the camera.

2. The method of claim 1, wherein projecting the light pattern comprises projecting a regular pattern selected from the group consisting of:
a regular grid of dots;
a regular non-grid array of dots;
a regular grid of lines; and
a regular non-grid array of lines.

3. The method of claim 1, wherein the camera comprises a light-field camera comprising an aperture, a main lens, a microlens array, and an image sensor positioned proximate the microlens array to capture at least the first light after passage of the first light through the main lens and the microlens array;
and wherein the image comprises a light-field image.

4. The method of claim 3, wherein using at least the second light to generate the depth map further comprises utilizing the light-field image to generate the depth map.

5. The method of claim 4, wherein using at least the second light to generate the depth map further comprises:
utilizing the light-field image to generate a first preliminary depth map;
utilizing the second light to generate a second preliminary depth map;
comparing the first preliminary depth map with the second preliminary depth map; and
based on results of comparing the first preliminary depth map with the second preliminary depth map, generating the depth map.

6. The method of claim 1, wherein capturing the first light comprises capturing the first light with the light pattern source inactive such that the second light is not captured with the first light;
wherein capturing the second light comprises capturing the second light with the light pattern source active;
and wherein capturing the second light is performed one of prior to commencing capture of the first light, and after completing capture of the first light.

7. The method of claim 1, wherein using at least the first light to generate the image comprises further using the second light to generate the image;
and wherein the method further comprises, at the processor, processing the image to at least partially remove effects of the second light from the image.

8. The method of claim 1, wherein projecting the light pattern comprises projecting the light pattern within a range of wavelengths that is not humanly visible.

9. The method of claim 8, wherein the camera comprises a light sensor;
wherein capturing the first light comprises capturing the first light with the light sensor;
and wherein capturing the second light comprises capturing the second light with the light sensor.

10. The method of claim 9, wherein the camera further comprises a light filter;
wherein capturing the first light further comprises using the light filter to project the first light at a first portion of the light sensor;
and wherein capturing the second light further comprises using the light filter to project the second light at a second portion of the light sensor.

11. The method of claim 10, wherein the camera comprises an aperture through which the first light and the second light enter the camera, wherein the light filter is positioned proximate the aperture;
wherein using the light filter to project the first light at the first portion of the light sensor comprises projecting the first light in a generally circular shape;
and wherein using the light filter to project the second light at the second portion of the light sensor comprises projecting the second light in a generally annular shape having an interior diameter sized such that the first portion fits within the second portion.

12. The method of claim 8, wherein the camera comprises a first light sensor and a second light sensor;
wherein capturing the first light comprises directing the first light at the first light sensor;
and wherein capturing the second light comprises directing the second light at the second light sensor.

13. The method of claim 12, wherein the camera further comprises a dichroic prism;
wherein directing the first light at the first light sensor comprises using the dichroic prism to direct the first light along a first path at the first light sensor;
wherein directing the second light at the second light sensor comprises using the dichroic prism to direct the second light along a second path at the second light sensor;
and wherein the second path is displaced from the first path by an angle of about 90°.

14. A non-transitory computer-readable medium for capturing an image and generating a depth map for the image, comprising instructions stored thereon, that when executed by a processor, perform the steps of:
causing a light pattern source to project a light pattern into a scene comprising one or more objects;
causing a camera to capture first light reflected from the one or more objects, wherein the first light comprises a reflection of light originating from one or more other light sources independent of the light pattern source;
causing the camera to capture second light reflected from the one or more objects, wherein the second light comprises a reflection of the light pattern from the one or more objects;
using at least the first light to generate the image, wherein the image depicts the scene; and
using at least the second light to generate a depth map indicative of distance between the one or more objects and the camera.

15. The non-transitory computer-readable medium of claim 14, wherein projecting the light pattern comprises projecting a regular pattern selected from the group consisting of:
a regular grid of dots;
a regular non-grid array of dots;
a regular grid of lines; and
a regular non-grid array of lines.

16. The non-transitory computer-readable medium of claim 14, wherein the camera comprises a light-field camera comprising an aperture, a main lens, a microlens array, and an image sensor positioned proximate the microlens array to capture at least the first light after passage of the first light through the main lens and the microlens array;
wherein the image comprises a light-field image;
and wherein using at least the second light to generate the depth map further comprises utilizing the light-field image to generate the depth map.

17. The non-transitory computer-readable medium of claim 14, wherein capturing the first light comprises capturing the first light with the light pattern source inactive such that the second light is not captured with the first light;
wherein capturing the second light comprises capturing the second light with the light pattern source active;
and wherein capturing the second light is performed one of prior to commencing capture of the first light, and after completing capture of the first light.

18. The non-transitory computer-readable medium of claim 14, wherein using at least the first light to generate the image comprises further using the second light to generate the image;
and wherein the non-transitory computer-readable medium further comprises instructions stored thereon, that when executed by a processor, process the image to at least partially remove effects of the second light from the image.

19. The non-transitory computer-readable medium of claim 14, wherein projecting the light pattern comprises projecting the light pattern within a range of wavelengths that is not humanly visible.

20. The non-transitory computer-readable medium of claim 19, wherein the camera comprises a light sensor and a light filter;
wherein capturing the first light further comprises using the light filter to project the first light at a first portion of the light sensor;
and wherein capturing the second light further comprises using the light filter to project the second light at a second portion of the light sensor.

21. The non-transitory computer-readable medium of claim 19, wherein the camera comprises a first light sensor and a second light sensor;
wherein capturing the first light comprises directing the first light at the first light sensor;
and wherein capturing the second light comprises directing the second light at the second light sensor.

22. A system for capturing an image and generating a depth map for the image, the system comprising:
a light pattern source configured to project a light pattern into a scene comprising one or more objects;
a camera configured to:
capture first light reflected from the one or more objects, wherein the first light comprises a reflection of light originating from one or more other light sources independent of the light pattern source; and
capture second light reflected from the one or more objects, wherein the second light comprises a reflection of the light pattern from the one or more objects; and
a processor configured to:
use at least the first light to generate the image, wherein the image depicts the scene; and
use at least the second light to generate a depth map indicative of distance between the one or more objects and the camera.

23. The system of claim 22, wherein the light pattern source is configured to project the light pattern by projecting a regular pattern selected from the group consisting of:
a regular grid of dots;
a regular non-grid array of dots;
a regular grid of lines; and
a regular non-grid array of lines.

24. The system of claim 22, wherein the camera comprises a light-field camera comprising an aperture, a main lens, a microlens array, and an image sensor positioned proximate the microlens array to capture at least the first light after passage of the first light through the main lens and the microlens array;
wherein the image comprises a light-field image;
and wherein the processor is configured to use at least the second light to generate the depth map by utilizing the light-field image to generate the depth map.

25. The system of claim 22, wherein the camera is configured to capture the first light by capturing the first light with the light pattern source inactive such that the second light is not captured with the first light;
wherein the camera is configured to capture the second light by capturing the second light with the light pattern source active;
and wherein the camera is configured to capture the second light one of prior to commencing capture of the first light, and after completing capture of the first light.

26. The system of claim 22, wherein the processor is configured to use at least the first light to generate the image by using the second light to generate the image;
and wherein the processor is further configured to process the image to at least partially remove effects of the second light from the image.

27. The system of claim 22, wherein the light pattern source is configured to project the light pattern by projecting the light pattern within a range of wavelengths that is not humanly visible.

28. The system of claim 27, wherein the camera comprises a light sensor and a light filter;
wherein the camera is configured to capture the first light by using the light filter to project the first light at a first portion of the light sensor;
and wherein the camera is configured to capture the second light by using the light filter to project the second light at a second portion of the light sensor.

29. The system of claim 27, wherein the camera comprises a first light sensor and a second light sensor;
wherein the camera is configured to capture the first light by directing the first light at the first light sensor;
and wherein the camera is configured to capture the second light by directing the second light at the second light sensor.
